(19) United States
(12) Patent Application Publication
(10) Pub. No.: US 2011/0143642 A1
(43) Pub. Date: Jun. 16, 2011

(54) VENTILATION LOAD-REDUCING APPARATUS AND VEHICLE AIR CONDITIONER USING THE SAME

(76) Inventors: Kazuo Nakajo, Saitama (JP); Hiroki Yoshioka, Saitama (JP); Takashi Fujita, Saitama (JP)

(21) Appl. No.: 13/003,807

(22) PCT Filed: Jul. 6, 2009
(86) PCT No.: PCT/JP2009/062270

§ 371 Date: Jan. 12, 2011

(30) Foreign Application Priority Data
Jul. 15, 2008 (JP) 2008-183821

(51) Int. Cl. B60H 1/26

(52) U.S. Cl. 454/141

(57) ABSTRACT

A ventilation load-reducing apparatus, which has a simple structure and is capable of further improving the efficiency of the heat recovery, and a vehicle air conditioner using the same are proposed. The ventilation load-reducing apparatus includes an inside air lead-out path 4 for ventilation which leads air of a vehicle-interior out of a vehicle from a rear side of the vehicle-interior, an outside air lead-in path 5 which leads outside air into a front side of the vehicle-interior, a ventilation heat recovery device 6 which recovers heat from the air led out through the inside air lead-out path 4, a recovered heat radiator 7 which releases the heat on the air led in through the outside air lead-in path 5, and a heat transmitter 8 which transmits the heat between the ventilation heat recovery device 6 and the recovered heat radiator 7. The ventilation load-reducing apparatus is independent of a refrigerant circulating system 9 of a vehicle air conditioner 2.

### TECHNICAL FIELD

The present invention relates to a ventilation load-reducing apparatus and a vehicle air conditioner using the same, and especially, to a ventilation load-reducing apparatus which reduces a load of ventilation when heating and a vehicle air conditioner using the same.

### BACKGROUND ART

In general, when heating a vehicle-interior by a heater, the heating has been performed by guiding engine-cooling water which is heated when cooling an engine to a heater core provided in the vehicle-interior and warming up air by the heater core.

However, today, a low-heat-generating engine or the like has been used along with highly promoted streamlining of an engine so that using exhaust heat of the engine has become difficult. In addition, in a car such as an electric car or the like, on which an engine is not mounted, it is necessary to perform the heating without using the exhaust heat from the engine.

Therefore, conventionally, an air conditioning cycle used as a vehicle air conditioner is applied, and a method for allowing the heating by refrigerant such as chlorofluorocarbon has been proposed. The method is a method for allowing the heating by circulating the refrigerant, which circulates in an air-cooling cycle used when cooling air, in a direction opposite to a direction in which the refrigerant circulates when cooling the air. The method is in a system which is a so-called heat pump cycle in which the refrigerant is compressed by a compressor to be highly pressurized and heated, and led into a heat exchanger (which functions as an evaporator on air-cooling) to heat cold air led-in from an outside air lead-in inlet. The system is so called a heat pump cycle.

In the method, a temperature of air blown into the vehicle-interior is adjusted to be a suitable temperature by a power of the compressor. Therefore, if the air led-in from the outside air lead-in inlet is, for example, as cold as −20° C., a increased power for the compressor in required.

On the other hand, in a case of an electric car or the like, a cruising distance changes according to a power to be consumed in the car as a whole. Therefore, the power to be consumed on the heating is required to be reduced as much as possible. For this reason, the load of ventilation on the heating has been desired to be reduced.

In the prior art, for example, a vehicle air conditioner which adopts a method for heating by use of the heat pump cycle is proposed. The vehicle air conditioner includes an exhaust heat recovery device provided on an inside air lead-out path which communicates between a vehicle-interior and a vehicle-exterior to lead air in the vehicle-interior out of the vehicle-interior for ventilation. The exhaust heat recovery device is connected in parallel to the heat pump cycle (for example, see Patent Document 1).

According to the structure as described-above, the refrigerant flows not only into the heat pump cycle but also into the exhaust heat recovery device. Therefore, when the heating is performed while outside air is led in, the refrigerant can obtain heat from the air to be led out to the vehicle-exterior for ventilation. Thus, it is possible to prevent energy from being vainly consumed away.

Further, an air conditioning apparatus for vehicle (hereinafter, referred to as a vehicle air conditioner), which includes an inside air lead-out path provided to be close to an outside air lead-in path to lead the air in the vehicle-interior out of the vehicle-interior and a total heat exchanger provided over the outside air lead-in path and the inside air lead-out path (for example, see Patent Document 2), is proposed. In the vehicle air conditioner, when the heating is performed while the outside air is led in, the heat of the air in the outside air lead-in path and the inside air lead-out path is exchanged by the total heat exchanger so that the load of compressor is reduced. Thus, it is possible to conserve energy.

### CITATION LIST

### Patent Document

Patent Document 1: Japanese Utility Model Publication No. Hei 6-6024
Patent Document 2: Japanese Patent Application Publication No. 2000-318422

### SUMMARY OF INVENTION

### Problems to be Solved by the Invention

Here, the problem is that, in the vehicle air conditioner disclosed in the Patent Document 1, a duct line which communicates between the exhaust heat recovery device and the heat pump cycle is integrated with the heat pump cycle. Therefore, the refrigerant is shared as the refrigerant which flows in the heat pump cycle and the refrigerant which flows in the duct line.

Therefore, it is difficult to newly mount such a duct line on the existing heat pump cycle. In addition, in order to mount such a duct line on the vehicle air conditioner, it is necessary to mount a controller, which controls the flow of the refrigerant, and an electromagnetic valve or the like. It causes complication of a circuit and an increase of a number of parts and it is also necessary to change an entire temperature controlling system. Thus, it is not practical.

In addition, in the vehicle air conditioner disclosed in the Patent Document 2, the heat exchange between the air from the inside air lead-out path and the air from the outside air lead-in path needs to be performed on a part where both of the paths abut on each other.

Here, when a total heat exchange is performed on the part where both of the paths abut on each other, there is a problem in that the inside air lead-out path needs to be extended to reach the outside air lead-in path so that the heat of the air which passes through the inside air lead-out path is released before the heat reaches the total heat exchanger.

The problem as described above arises when the heating is performed by the heat pump cycle. However, reducing the ventilation load is required similarly when heating in a car which has an apparatus (a heated water producing apparatus) configured to produce heated water by power other than the engine or even in a car having the engine.

### Means to Solve the Problems

The present invention aims to provide a ventilation load-reducing apparatus, which has a simple structure and improvable efficiency of the heat recovery, and a vehicle air conditioner using the apparatus.

A ventilation load-reducing apparatus of the present invention includes an inside air lead-out path for ventilation, configured to communicate between a vehicle-interior and a vehicle-exterior of a vehicle to lead air of the vehicle-interior out of the vehicle from a rear side of the vehicle-interior, an outside air lead-in path configured to communicate between the vehicle-interior and the vehicle-exterior to lead outside air into a front side of the vehicle-interior from the vehicle-exterior, a ventilation heat recovery device provided in the inside air lead-out path and configured to recover heat from air to be led out through the inside air lead-out path, a recovered heat radiator provided in the outside air lead-in path and configured to radiate the heat on air led in through the outside air lead-in path, and a heat transmitter configured to transmit the heat between the ventilation heat recovery device and the recovered heat radiator. The ventilation load-reducing apparatus is independently provided from a refrigerant circulating system of an air conditioner of the vehicle.

Preferably, the heat transmitter includes a duct line which communicates between the ventilation heat recovery device and the recovered heat radiator and an antifreeze solution which transmits the heat by circulating in the duct line. The duct line includes a water pump configured to circulate the antifreeze solution in a system having the duct line, the ventilation heat recovery device, and the recovered heat radiator.

Preferably, the heat transmitter is a heat pipe which communicates between the ventilation heat recovery device and the recovered heat radiator and transmits the heat.

Preferably, the inside air lead-out path includes a ventilation fan configured to forcibly blow the air of the vehicle-interior led out through the inside air lead-out path into the ventilation heat recovery device.

Preferably, the vehicle air conditioner of the present invention includes the above-described ventilation load-reducing apparatus.

### Effect of the Invention

According to the present invention, it is possible to achieve a ventilation load-reducing apparatus, which has a simple structure and improvable efficiency of the heat recovery, and a vehicle air conditioner using the apparatus.

### BRIEF DESCRIPTION OF THE DRAWINGS

FIG. 1 is a plan perspective view showing a vehicle 100 on which a ventilation load-reducing apparatus 1 for explaining an embodiment of the present invention and a vehicle air conditioner 2 using the same are mounted as viewed down from above.

FIG. 2 is a partially enlarged view showing a detail of a heat transmitter 8 shown in FIG. 1.

FIG. 3 is a partially enlarged view showing a heat pipe 20 which substitutes for duct lines 16, 16′ shown in FIG. 1.

### MODE FOR CARRYING OUT THE INVENTION

Hereinafter, an embodiment for realizing a ventilation load-reducing apparatus of the present invention and a vehicle air conditioner using the same will be described with reference to the accompanying drawings.

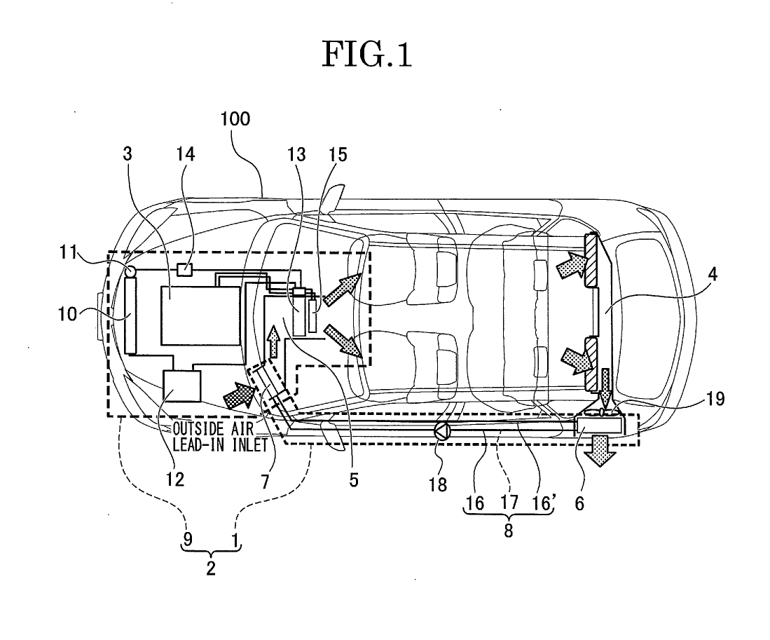

FIG. 1 is a plan perspective view showing a vehicle 100 on which a ventilation load-reducing apparatus 1 for explaining an embodiment of the present invention and a vehicle air conditioner 2 using the same are mounted as viewed down from above.

In addition, in the present embodiment, not about the vehicle air conditioner, which performs the heating by using a heat pump cycle but about the vehicle air conditioner, which performs the heating by using an apparatus (a heated water producing apparatus 3) configured to produce heated water will be described.

In the FIG. 1, the plan perspective view shows a state where a forward direction of the vehicle 100 is indicated as a leftward direction.

As shown in FIG. 1, on a rear side of the vehicle 100, an inside air lead-out path 4 which communicates between a vehicle-interior and a vehicle-exterior of a vehicle to lead air of the vehicle-interior out of the vehicle-interior for ventilation is provided. In addition, on a front side of the vehicle 100, an outside air lead-in path 5 which communicates between the vehicle-interior and the vehicle-exterior to lead outside air into the vehicle-interior from the vehicle-exterior is provided.

On the inside air lead-out path 4, a ventilation heat recovery device 6 which recovers heat from the vehicle-interior air led out through the inside air lead-out path 4 is provided. In addition, on the outside air lead-in path 5, a recovered heat radiator 7 which radiates the heat on the air led in through the outside air lead-in path 5 is provided. Further, between the ventilation heat recovery device 6 and the recovered heat radiator 7, a heat transmitter 8 which transmits the heat between the ventilation heat recovery device 6 and the recovered heat radiator 7 is provided.

Here, the outside air lead-in path 5 is a path in which one end of the outside air lead-in path 5 is open to a vehicle-interior side and the other end is open to a vehicle-exterior side. The ventilation load-reducing apparatus in which the outside air lead-in path 5 and an inside air circulating path are independently provided from each other will be described in the present embodiment. However, for example, if a structure is such that the outside air lead-in path 5 and an inside air circulating path join, and when the inside air circulating path is closed and the outside air lead-in path 5 is open, the outside air lead-in path 5 includes a joined part of the outside air lead-in path 5 and the inside air circulating path.

In addition, on the front side of the vehicle 100, a refrigerant circulating system 9 (heat pump cycle) which is used when cooling is provided. The refrigerant circulating system 9 includes a condenser 10, a liquid tank 11, compressor 12, evaporators 13, and an expansion valve 14. The refrigerant circulating system 9 circulates the refrigerant so that cold air flows in the vehicle-interior from the evaporator 13 positioned at the outside air lead-in path 5.

Further, on the front side of the vehicle 100, a heated water producing apparatus 3 and a heater core 15, which are used on the heating, are provided. The heater core 15 is disposed close to an opening of the vehicle-interior side of the outside air lead-in path 5 to be closer to the opening than the evaporator 13 is.

The ventilation load-reducing apparatus 1 which comprises the ventilation heat recovery device 6, the recovered heat radiator 7, and the heat transmitter 8 is constituted independently from the refrigerant circulating system 9.

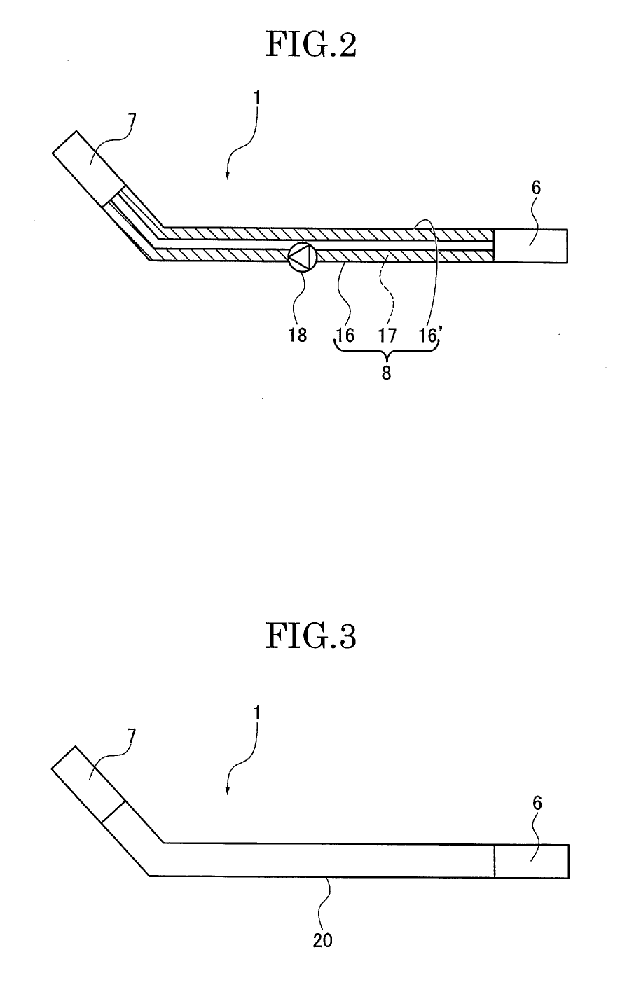

FIG. 2 is a partially enlarged view showing a detail of the heat transmitter 8 shown in FIG. 1. As shown in FIG. 2, the heat transmitter 8 of the ventilation load-reducing apparatus 1 of the present embodiment includes duct lines 16 and 16′ which communicate between the ventilation heat recovery device 6 and the recovered heat radiator 7 and an antifreeze solution 17 which circulates in the duct lines 16, 16′ to transmit the heat.

In addition, in order to prevent the heat recovered by the ventilation heat recovery device 6 from being released outward before the heat is transmitted to the recovered heat radiator 7, peripheries of the duct lines 16, 16′ are preferably covered by a thermal insulator or the like.

Further, on the duct lines 16, 16′, a water pump 18 which circulates the antifreeze solution 17 through a system having the duct lines 16, 16′, the ventilation heat recovery device 6, and the recovered heat radiator 7 is provided.

Furthermore, on the inside air lead-out path 4, a ventilation fan 19 which forcibly blows the vehicle-interior air led out by the inside air lead-out path 4 into the ventilation heat recovery device 6 is provided. Here, since the ventilation fan 19 serves a function to forcibly blow the air of the inside air lead-out path 4 into the ventilation heat recovery device 6, the ventilation fan 19 is provided upstream of the ventilation heat recovery device 6 within the inside air lead-out path 4.

Next, an operation of the ventilation load-reducing apparatus 1 of the present embodiment when heating and the vehicle air conditioner 2 using the same will be described.

When the vehicle-interior is heated by a heater, water heated by the heated water producing apparatus 3 is circulated to the vehicle-interior side. At this time, when the vehicle-interior air is circulated, a window is fogged by humidity produced by humans. Therefore, the outside air is normally led in when the heating is performed. At this time, the outside air led in by the outside air lead-in path 5 is heated by the heater core 15 so that heated air is blew into the vehicle-interior.

Further, the vehicle-interior air is led out through the inside air lead-out path 4 by the ventilation and blew into the ventilation heat recovery device 6 by the ventilation fan 19. Because of this, the heat transmission is performed between the air in the vehicle-interior and the antifreeze solution 17 inside the ventilation heat recovery device 6 so that the heat of the heated air in the vehicle-interior is recovered. Then, the antifreeze solution 17 is circulated by the water pump 18 so that the antifreeze solution 17 flows from the ventilation heat recovery device 6 through the duct line 16 and reaches the recovered heat radiator 7. Then, on the recovered heat radiator 7, the heat is exchanged between the antifreeze solution 17 and the cold outside air led in through the outside air lead-in path 5 so that the outside air led into the outside air lead-in path 5 is heated.

Then, the air heated by the ventilation load-reducing apparatus 1 is further heated by the heater core 15 and blown into the vehicle-interior to heat the vehicle-interior.

In addition, after the heat is released by the antifreeze solution 17 at the recovered heat radiator 7, the antifreeze solution 17 passes through the duct line 16′ to return to the ventilation heat recovery device 6.

According to the ventilation load-reducing apparatus 1 of the present embodiment and the vehicle air conditioner 2 using the same as constituted as described above, when heating the vehicle-interior while the outside air is led in, the heat of the vehicle-interior air is not wasted but recycled after once a temperature of the vehicle-interior air rises. That is, when the heat is transmitted by the antifreeze solution 17 while being circulated, the heat is transmitted from the antifreeze solution 17 to the led-in outside air in the recovered heat radiator 7 so that the outside air is heated by degrees corresponding to degrees by which the temperature of the antifreeze solution falls.

For example, if the outside air is as cold as −20° C., the outside air led in through the outside air lead-in path 5 is capable of being heated up to around 0° C. by the radiated heat in the recovered heat radiator 7. Therefore, on the refrigerant circulating system 9, only the power as same as the power consumed when the outside air is at 0° C. is required so that energy can be saved.

As described above, in the ventilation load-reducing apparatus 1 of the present embodiment, the ventilation heat recovery device 6 is provided on the inside air lead-out path 4 positioned at the rear side of the vehicle-interior, and the recovered heat radiator 7 is provided on the outside air lead-in path 5 positioned at the front side of the vehicle-interior. Therefore, the heat of the heated air of the vehicle-interior can be efficiently recovered and released so that a heat recovering efficiency can be improved.

That is to say, in the structure described in Patent Document 2, the heat is recovered by the total heat exchanger after the heat of the air led out by the ventilation moves from the rear side to the front side in the inside air lead-out path. In contrast, in the ventilation load-reducing apparatus 1 of the present embodiment, the heat of the air led out by the ventilation is quickly recovered at the rear side. Therefore, the heat is prevented from being released before the collected heat reaches the ventilation heat recovery device 6 so that the heat can be efficiently recovered. Also, the recovered heat radiator 7 radiating the recovered heat is disposed close to the opening which is positioned at the front side of the vehicle to blow the heated air (in the vehicle-interior). Thus, the heat radiation can be efficiently performed.

Advantageous effects as described above is especially effective for an electric car or the like which does not have a heat source (engine) and engine cooling water and requires another electricity (energy) to produce heat.

For example, when the power consumed by the water pump 18 is around 60 W and the power consumed by the ventilation fan 19 is around 60 W, recovered heat quantity about 1400 W (180 m³/h) can be recovered and the efficiency is about η=12.

In addition, the recovered heat quantity about 1400 W (180 m³/h) is calculated by the following formula 1.

Heat quantity Qa to rise the temperature of the outside air of −20° C. up to 0° C. is

$$Qa = Ga \times ya \times Cpa \times Δ t \\ Therefore , it is \\ Qa = 180 \times 1.39 \times 0.24 \times 20 = 1393 W ⇋ 1400 W \qquad ( formula 1 )$$

Further, the ventilation load-reducing apparatus 1 of the present embodiment has a simple structure which includes only the two heat exchangers (the ventilation heat recovery device 6 and the recovered heat radiator 7) and the heat transmitter 8, and a small number of components is used. Therefore, it is easy to be newly mounted on the existing air conditioner afterward.

Further, since the ventilation load-reducing apparatus 1 is independently provided from the refrigerant circulating system 9, the refrigerant is not shared. Therefore, when the ventilation load-reducing apparatus 1 is mounted on the existing air conditioner afterward, a controller which controls the flow of the refrigerant, an electromagnetic valve, or the like are not required. Also, a change or the like in an entire temperature controlling system is unnecessary.

Furthermore, on the conventional vehicle air conditioner, when the temperature of the outside air is low, the temperature and pressure of the condenser 10 in the refrigerant circulating system 9 fall compared with that of the other parts in the refrigerant circulating system 9. This causes the refrigerant to flow into the condenser 10 from a gap or the like of a not-illustrated check valve so that the refrigerant accumulates in a liquid form, that is, a so-called “sleeping of refrigerant” tends to occur. When such a “sleeping of refrigerant” occurs, an amount of the refrigerant in the refrigerant circulating system 9 when heating fails so that the heating capability runs short. Therefore, a refrigerant recovering operation is required to be performed such that the refrigerant which accumulates in the condenser 10 is quickly returned back to the refrigerant circulating system 9.

The refrigerant recovering operation is especially needed to be performed when the structure of the apparatus is such that the refrigerant is shared in the entire vehicle air conditioner and the refrigerant is circulated to the rear side of the vehicle as described in Patent Document 1.

On the other hand, the ventilation load-reducing apparatus 1 of the present embodiment is, as described above, independently provided from the refrigerant circulating system 9, and the refrigerant is not shared with the refrigerant circulating system 9. Therefore, it does not require the refrigerant recovering operation for resolving the “sleeping of refrigerant” as the case having the structure of the apparatus described in Patent Document 1.

Further, since the ventilation load-reducing apparatus 1 has a system which is independent from the refrigerant circulating system 9, the ventilation load-reducing apparatus 1 can be provided no matter whether the refrigerant circulating system 9 is mounted on the air conditioner or not.

Furthermore, according to the ventilation load-reducing apparatus 1 of the present embodiment and the vehicle air conditioner 2 using the same, the antifreeze solution 17 transmitting the heat circulates in the duct lines 16, 16′ so that the antifreeze solution 17 does not freeze in the duct lines 16, 16′ even when the temperature of the outside air is low.

Further, according to the ventilation load-reducing apparatus 1 of the present embodiment and the vehicle air conditioner 2 using the same, on the inside air lead-out path 4, the ventilation fan 19 which forcibly blows air led out through the inside air lead-out path 4 into the ventilation heat recovery device 6 is provided. Therefore, the air exhausted from the vehicle-interior can be efficiently blown into the ventilation heat recovery device 6 so that the heat recovering efficiency is improved.

As described above, the ventilation load-reducing apparatus of the present invention includes the ventilation heat recovery device provided on the inside air lead-out path, the recovered heat radiator provided on the outside air lead-in path, and the heat transmitter which transmits the heat between the ventilation heat recovery device and the recovered heat radiator. In addition, the apparatus has a structure independent from the refrigerant circulating system of the vehicle air conditioner. Thus, achieving the apparatus having a simple structure is realized, and the efficiency of the heat recovery can be more improved.

According to the ventilation load-reducing apparatus of the present invention constituted as described above, the heating is performed such that the heat of the air to be led out from the vehicle-interior for ventilation is recovered by the ventilation heat recovery device provided on the inside air lead-out path positioned at the rear side of the vehicle-interior, the recovered heat is transmitted to the recovered heat radiator positioned at the front side of the vehicle-interior by the heat transmitter, and the cold outside air is heated by the recovered heat radiator. As described above, the ventilation load-reducing apparatus of the present invention has a simple structure and is capable of further improving the efficiency of the heat recovery. Thus, the load of the ventilation can be reduced.

In the present embodiment, the vehicle air conditioner 2 having a configuration in which the cooling is performed by the refrigerant circulating system 9 and the heating is performed by the ventilation load-reducing apparatus 1, the heated water producing apparatus 3, and the heater core 15 is described. Such a vehicle air conditioner 2 is suitable for the electric car or the like which does not have the engine.

However, the ventilation load-reducing apparatus of the present invention and the vehicle air conditioner using the same can be applied not only to an electric car or the like which does not have the engine but also to a car having the engine. When the car has the engine, the heated water producing apparatus 3 is replaced by the engine, and the engine cooling water is circulated instead of the heated water.

Further, likewise, the ventilation load-reducing apparatus of the present invention and the vehicle air conditioner using the same can be applied to a car which does not have the heated water producing apparatus 3 or the engine and performs the heating by using the refrigerant circulating system 9.

In addition, in the present embodiment, the apparatus in which the heat transmitter 8 is comprised of the duct lines 16, 16′, which communicates between the ventilation heat recovery device 6 and the recovered heat radiator 7, and the antifreeze solution 17 which circulates in the duct lines 16, 16′ to transmit the heat is described. However, as shown in FIG. 3, the heat pipe 20 can be used instead of the antifreeze solution 17 and the duct lines 16, 16′. If the heat pipe 20 is used, neither the antifreeze solution 17 nor the water pump 18 which circulates the antifreeze solution 17 is necessary so that the number of components can be cut down.

Further, similarly on the structure of the apparatus which adopts the heat pipe 20 as the heat transmitter 8, the heat release is preferably prevented by, for example, wrapping a thermal insulator around the heat pipe 20.

Furthermore, on the present embodiment, as shown in FIG. 1, it is described that the ventilation load-reducing apparatus 1 is mounted on the left side of the vehicle 100 (downside in FIG. 1). However, it is not limited to the embodiment, and the ventilation load-reducing apparatus 1 of the present invention can be mounted either on the left side or the right side of the vehicle, or on both of the left and right sides.

In addition, a position where the heat transmitter 8 of the present invention is mounted on the vehicle 100 is not limited as long as the heat transmitter 8 is capable of transmitting the heat by communicating the ventilation heat recovery device 6 and the recovered heat radiator 7. For example, the heat transmitter 8 can be mounted on a side sill, on a vehicle-interior, or on a vehicle-exterior (for example, on a floor tunnel part for leading a propeller shaft therethrough).

Further, in the present embodiment, it is described that the ventilation fan 19 is provided on the inside air lead-out path 4. However, the apparatus may not comprise the ventilation fan 19, and the warm air led out from the vehicle-interior may be naturally blown into the ventilation recovery device 6 by the pressure which is generated when the air of the vehicle-interior is blown into the inside air lead-out path 4 for ventilation.

### DESCRIPTION OF NUMERIC CODES

1 ventilation load-reducing apparatus
2 vehicle air conditioner
3 heated water producing apparatus
4 inside air lead-out path
5 outside air lead-in path
6 ventilation heat recovery device
7 recovered heat radiator
8 heat transmitter
9 refrigerant circulating system
10 condenser
11 liquid tank
12 compressor
13 evaporator
14 expansion valve
15 heater core
16, 16′ duct line
17 antifreeze solution
18 water pump
19 ventilation fan
20 heat pipe
100 vehicle

1. A ventilation load-reducing apparatus comprising:
an inside air lead-out path for ventilation, configured to communicate between a vehicle-interior and a vehicle-exterior of a vehicle to lead air of the vehicle-interior out of the vehicle from a rear side of the vehicle-interior;
an outside air lead-in path configured to communicate between the vehicle-interior and the vehicle-exterior to lead outside air into a front side of the vehicle-interior from the vehicle-exterior;
a ventilation heat recovery device provided on the inside air lead-out path and configured to recover heat from air to be led out through the inside air lead-out path;
a recovered heat radiator provided on the outside air lead-in path and configured to radiate the heat on the air led in through the outside air lead-in path; and
a heat transmitter configured to transmit the heat between the ventilation heat recovery device and the recovered heat radiator, wherein
the ventilation load-reducing apparatus is independently provided from a refrigerant circulating system of an air conditioner of the vehicle.

2. The ventilation load-reducing apparatus according to claim 1, wherein:
the heat transmitter includes a duct line configured to communicate between the ventilation heat recovery device and the recovered heat radiator and an antifreeze solution configured to circulate in the duct line to transmit the heat; and
the duct line includes a water pump configured to circulate the antifreeze solution in a system having the duct line, the ventilation heat recovery device, and the recovered heat radiator.

3. The ventilation load-reducing apparatus according to claim 1, wherein:
the heat transmitter is a heat pipe configured to communicate between the ventilation heat recovery device and the recovered heat radiator to transmit the heat.

4. The ventilation load-reducing apparatus according to claim 1, wherein
the inside air lead-out path includes a ventilation fan configured to forcibly blow the air led out through the inside air lead-out path into the ventilation heat recovery device.

5. A vehicle air conditioner comprising
the ventilation load-reducing apparatus according to claim 1.

6. The ventilation load-reducing apparatus according to claim 2, wherein
the inside air lead-out path includes a ventilation fan configured to forcibly blow the air led out through the inside air lead-out path into the ventilation heat recovery device.

7. The ventilation load-reducing apparatus according to claim 3, wherein
the inside air lead-out path includes a ventilation fan configured to forcibly blow the air led out through the inside air lead-out path into the ventilation heat recovery device.

8. A vehicle air conditioner comprising
the ventilation load-reducing apparatus according to claim 2.

9. A vehicle air conditioner comprising
the ventilation load-reducing apparatus according to claim 3.

10. A vehicle air conditioner comprising
the ventilation load-reducing apparatus according to claim 4.
